(19) United States
(12) Patent Application Publication
(10) Pub. No.: US 2025/0050586 A1
(43) Pub. Date: Feb. 13, 2025

(54) ADDITIVE MANUFACTURING CONDITION SEARCH DEVICE AND ADDITIVE MANUFACTURING CONDITION SEARCH METHOD

(71) Applicant: HITACHI, LTD., Chiyoda-ku, Tokyo (JP)

(72) Inventors: Hirotsugu KAWANAKA, Tokyo (JP); Tomonori KIMURA, Tokyo (JP); Isamu TAKAHASHI, Tokyo (JP); Yusuke YASUDA, Tokyo (JP); Seunghwan PARK, Tokyo (JP)

(73) Assignee: HITACHI, LTD., Chiyoda-ku, Tokyo (JP)

(21) Appl. No.: 18/724,042

(22) PCT Filed: Nov. 9, 2022
(86) PCT No.: PCT/JP2022/041748

§ 371 Date: Jun. 25, 2024

(30) Foreign Application Priority Data
Dec. 28, 2021 (JP) 2021-214872

(51) Int. Cl. B29C 64/393; B29C 64/153; B33Y 50/02; G06F 30/27; G06F 113/10

(52) U.S. Cl. CPC B29C 64/393; B29C 64/153; B33Y 50/02; G06F 30/27; G06F 2113/10

(57) ABSTRACT

An additive manufacturing condition search device includes a defect database that accumulates a material, shape information, an additive manufacturing condition, monitoring information during modeling, and defect information in association with each other, a first machine learning unit that outputs an additive manufacturing condition corresponding to material information and device information, and outputs a new additive manufacturing condition from a combination of a plurality of the additive manufacturing conditions and the defect information, a specification unit that causes an additive manufacturing apparatus to perform modeling by the additive manufacturing condition, acquires the monitoring information during modeling, and acquires the shape information and the defect information by inspection of a modeled object, a second machine learning unit in which a model trained by using the defect database as train data estimates defect information of the modeled object from the monitoring information and stores the defect information in the defect database, and a determination unit that determines whether or not the defect information of the modeled object has achieved an evaluation target value.

### TECHNICAL FIELD

The present invention relates to an additive manufacturing condition search device and an additive manufacturing condition search method.

### BACKGROUND ART

For example, a powder bed fusion system, a directed energy deposition system, and the like have been known as additive manufacturing (stacking modeling). In the powder bed fusion system, the additive manufacturing is performed by irradiation of a light beam (laser beam, electron beam, or the like) to powder spread flat. The powder bed fusion system includes selective laser melting (SLM) and electron beam melting (EBM). In the directed energy deposition system, the additive manufacturing is performed by controlling a position of a head that performs irradiation of a light beam and ejection of a powder material. The directed energy deposition system includes laser metal deposition (LMD), direct metal deposition (DMP), and the like.

On the other hand, for these kinds of additive manufacturing, it is necessary to set appropriate additive manufacturing conditions (recipes) in accordance with materials. In particular, in the powder bed fusion system, there are many types of parameters to be controlled, and much effort is required to derive appropriate additive manufacturing conditions.

Meanwhile, in recent years, artificial intelligence has rapidly developed along with improvement in processing speed of a computer, and for example, PTL 1 describes that laser machining condition data is generated by machine learning. The literature describes that quality determination of molding is performed by monitoring a state during molding.

### CITATION LIST

### Patent Literature

PTL 1: JP 2017-164801 A

### SUMMARY OF INVENTION

### Technical Problem

In the powder bed fusion, since there are many different factors for additive manufacturing conditions, it is not easy to determine optimal factors. There are factors such as a heat source output, a scanning speed, a scanning line interval, a scanning line length, and a stacking thickness only under a condition of filling an inside of the modeled object, and it is necessary to manufacture and evaluate many modeled objects in order to obtain an optimum condition. Thus, construction of a process window has a problem that enormous cost and time are required and a problem that a process window having an individual difference is constructed by a person who conducts an experiment.

On the other hand, a method for comparing a control factor and a modeling result by using machine learning and optimizing regression analysis is used. However, even though the present method is used, since a control factor of the additive manufacturing condition and a settable range are wide, when conditions are comprehensively set, the number of evaluations increases, and many conditions in which the manufacturing result (evaluation score) deteriorates are also included. When many conditions in which the manufacturing result deteriorates are included, it takes time to converge the analysis until proper condition search.

In addition, in the powder bed fusion, since evaluation samples under a plurality of conditions are manufactured at a time, when there are many samples with poor manufacturing results, the samples under good conditions may be adversely affected. For example, in the case of the sample with the poor result, the sample comes into contact with a tool called a squeegee that pushes powder at the time of powder spreading, generates relatively large spatter, and scatters in a manufacturing region under good conditions. In addition, there is also a problem that it takes time for a work to be allocated by a person in accordance with a control factor that can set an initial learning condition.

Therefore, an object of the present invention is to improve efficiency of searching for an optimal solution of an additive manufacturing condition of an additive manufacturing apparatus.

### Solution to Problem

In order to solve the above problems, an additive manufacturing condition search device of the present invention includes a defect database that accumulates a material, shape information, manufacturing condition, monitoring information during modeling, and defect information in association with each other, a first machine learning unit that outputs an additive manufacturing condition corresponding to material information and device information, and outputs a new additive manufacturing condition from a combination of a plurality of the additive manufacturing conditions and the defect t information, a specification unit that causes an additive manufacturing apparatus to perform modeling by the additive manufacturing condition, acquires the monitoring information during modeling, and acquires the shape information and the defect information by inspection of a modeled object, a second machine learning unit in which a model trained by using the defect database as train data estimates defect information of the modeled object from the monitoring information and stores the defect information in the defect database, and a determination unit that determines whether or not the defect information of the modeled object has achieved an evaluation target value.

An additive manufacturing condition search method of the present invention includes a step of outputting an additive manufacturing condition corresponding to material information and device information or outputting a new additive manufacturing condition from a combination of a plurality of additive manufacturing conditions and defect information, a step of causing an additive manufacturing apparatus to perform modeling by the additive manufacturing condition, acquiring monitoring information during modeling, and acquiring shape information and defect information by inspection of a modeled object, a step of estimating, by a model trained by using, as train data, a defect database as a combination of the monitoring information during modeling and the defect information, defect information of the modeled object from the monitoring information, and storing the defect information in the defect database, and a step of determining whether or not the defect information of the modeled object has achieved an evaluation target value.

Other means will be described in the mode for carrying out the invention.

### Advantageous Effects of Invention

According to the present invention, it is possible to improve the efficiency of searching for the optimal solution of the additive manufacturing condition of the additive manufacturing apparatus.

### BRIEF DESCRIPTION OF DRAWINGS

FIG. 1 is a configuration diagram illustrating an example of an additive manufacturing apparatus.

FIG. 2 is a schematic diagram illustrating an example of a standard sample shape.

FIG. 3 is a developed view illustrating an example of the standard sample shape.

FIG. 4 is a sectional view illustrating an example of the standard sample shape.

FIG. 5 is a diagram illustrating three types of regions of a section of the standard sample.

FIG. 6 is a schematic front view of the standard sample.

FIG. 7 is a schematic side view of the standard sample.

FIG. 8 is a diagram illustrating an example of a method for measuring an additively manufactured standard sample.

FIG. 9 is a diagram illustrating an example of the method for measuring the additively manufactured standard sample.

FIG. 10 is a diagram illustrating an example of the method for measuring the additively manufactured standard sample.

FIG. 11 is a block diagram illustrating a hardware configuration example of an additive manufacturing condition search device.

FIG. 12 is a block diagram illustrating a functional configuration example of an additive manufacturing condition search device.

FIG. 13 is an explanatory diagram illustrating a scanning line interval among input parameters.

FIG. 14 is an explanatory diagram of a scanning line interval, a scanning pattern, a scanning line length, and an offset amount between scanning patterns.

FIG. 15 is an explanatory diagram of an offset amount from contour line irradiation.

FIG. 16 is a block diagram illustrating a functional configuration example of a first machine learning unit.

FIG. 17 is a diagram illustrating physical property values of materials.

FIG. 18 is a graph representing a relationship between an energy density of each material and a density of an additively manufactured product.

FIG. 19 is a block diagram illustrating a functional configuration example of a second machine learning unit.

FIG. 20 is a flowchart illustrating search processing by the additive manufacturing condition search device.

FIG. 21 is a flowchart of additive manufacturing condition search processing in the additive manufacturing condition search device.

FIG. 22 is a flowchart of additive manufacturing condition search processing in an additive manufacturing condition search device of a second embodiment.

### DESCRIPTION OF EMBODIMENTS

Hereinafter, embodiments for carrying out the present invention will be described in detail with reference to the drawings.

### <<Additive Manufacturing Apparatus>>

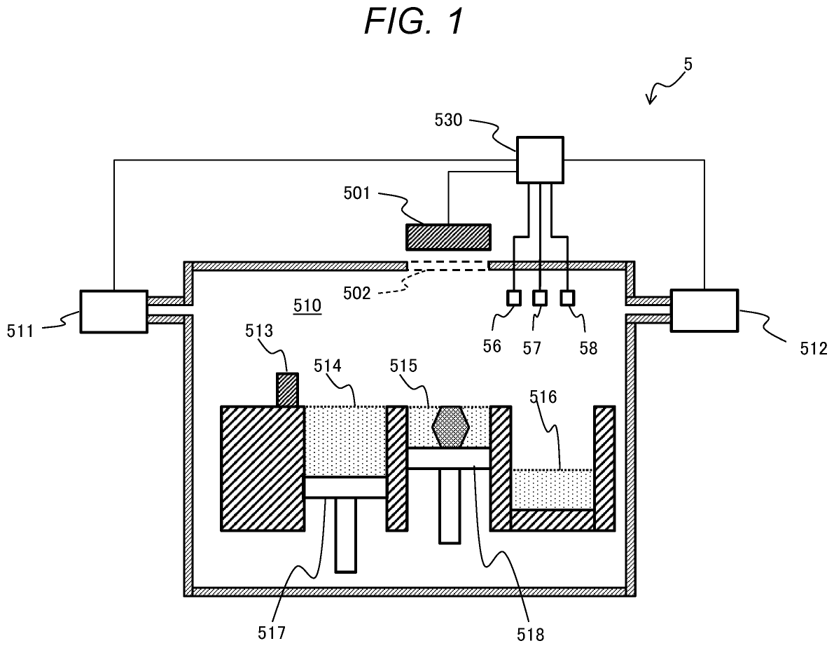

FIG. 1 is a configuration diagram illustrating an example of an additive manufacturing apparatus 5.

An additive manufacturing apparatus 5 to which an additive manufacturing condition search device and an additive manufacturing condition search method of the present embodiment can be applied will be described with reference to FIG. 1. The additive manufacturing apparatus 5 is of a powder bed fusion type. The additive manufacturing apparatus 5 melts and solidifies metal powder by irradiating the metal powder laid in a layer with a light beam and heating the metal powder. Then, the additive manufacturing apparatus 5 manufactures a modeled object by repeating formation of a powder bed and the light beam irradiation.

The additive manufacturing apparatus 5: includes a chamber 510, a gas supply unit 511, an exhaust mechanism 512, a material supply unit 514, an additive manufacturing unit 515, a collection unit 516, a recoater 513, a light beam source 501, and a control unit 530.

The chamber 510 houses each part of the additive manufacturing apparatus 5 except the light beam source 501 and the exhaust mechanism 512. The chamber 510 has a transmission window 502 into which protective glass is fitted. The transmission window 502 transmits the light beam irradiated from the light beam source 501 disposed outside the chamber 510 and reaches the powder bed placed on a stage 518 of the additive manufacturing unit 515 inside the chamber 510.

In addition, a temperature sensor 56, a pressure sensor 57, an oxygen sensor 58, and the like are installed in the additive manufacturing apparatus 5.

The temperature sensor 56 includes a contact type temperature sensor such as a thermocouple that measures a temperature of the stage 518, and a non-contact type temperature sensor such as an infrared radiation thermometer that measures a temperature of the powder bed formed on the stage 518.

The pressure sensor 57 measures a pressure in a reduced pressure environment within the chamber 510. The oxygen sensor 58 measures an oxygen amount (oxygen concentration) in the reduced pressure environment within the chamber 510. In addition, although not illustrated, the chamber 510 may include, for example, a camera that captures an image of the powder bed formed on the stage 518 of the additive manufacturing unit 515.

The gas supply unit 511 is connected to the chamber 510 and supplies an inert gas to an inside of the chamber 510. The gas supply unit 511 includes, for example, a gas supply source and a control valve (not illustrated). The gas supply source is formed by a high-pressure tank filled with the inert gas. The control valve is controlled by the control unit 530, and controls a flow rate of the inert gas supplied from the gas supply source to the chamber 510. For example, nitrogen or argon can be used as the inert gas.

The exhaust mechanism 512 is formed by a vacuum pump and is connected to the chamber 510 via a pipe for evacuation. The exhaust mechanism 512 may be controlled by the control unit 530, and may discharge the gas within the chamber 510 to set the inside of the chamber 510 to a vacuum pressure lower than an atmospheric pressure and set the inside of the chamber 510 to the reduced pressure environment.

The material supply unit 514 is provided in a concave shape capable of storing material powder, and has an opening portion at an upper end with an upper portion opened. The material supply unit 514 includes a vertically movable stage 517 for placing and supplying the material powder. The stage 517 constitutes a bottom wall of the material supply unit 514. The stage 517 is provided to be movable up and down at a predetermined pitch by an appropriate lifting mechanism. The lifting mechanism of the stage 517 is connected to the control unit 530 and is controlled by the control unit 530. In addition, the material supply unit 514 may be a method for dropping and supplying the material powder instead of a lifting type.

Examples of the material powder used for additive manufacturing of the modeled object include powders of metal materials such as hot work tool steel, copper, a titanium alloy, a nickel alloy, an aluminum alloy, a cobalt-chromium alloy, and stainless steel, powders of resin materials such as polyamide, and powders of ceramics.

Similarly to the material supply unit 514 described above, the additive manufacturing unit 515 is provided in a concave shape capable of storing the material powder, and has an opening portion at an upper end with an upper portion opened. The additive manufacturing unit 515 has the stage 518 for laying the material powder to form the powder bed. The stage 518 constitutes a bottom wall of the additive manufacturing unit 515. The material powder supplied from the material supply unit 514 and the modeled object manufactured by additive manufacturing are placed on the stage 518.

The opening portion of the additive manufacturing unit 515 and the opening portion of the material supply unit 514 have substantially the same height in a vertical direction and are aligned in a substantially horizontal direction. Similarly to the material supply stage 517 described above, the stage 518 for additive manufacturing is provided to be movable up and down at a predetermined pitch by an appropriate lifting mechanism. In addition, the stage 518 may include a preheating mechanism including a heater for preheating the stage 518. The lifting mechanism and the preheating mechanism of the stage 518 are connected to, for example, the control unit 530 and are controlled by the control unit 530.

For example, similarly to the material supply unit 514 described above, the collection unit 516 is provided in a concave shape capable of storing the material powder, and has an opening portion at an upper end with an upper portion opened. In the example illustrated in FIG. 1, the bottom wall of the collection unit 516 is fixed to a lower end portion, but may be formed by a stage that is movable up and down similarly to the material supply unit 514 and the additive manufacturing unit 515.

The opening portion of the collection unit 516 and the opening portion of the additive manufacturing unit 515 have substantially the same height in the vertical direction, and are aligned substantially in the horizontal direction. The collection unit 516 stores and collects, for example, extra material powder supplied from the material supply unit 514 to the additive manufacturing unit 515 by the recoater 513.

The recoater 513 forms the powder bed on the stage 518 by carrying the material powder supplied from the material supply unit 514 onto the stage 518 of the additive manufacturing unit 515 and spreading the material powder while leveling the material powder. The recoater 513 includes a moving mechanism. The moving mechanism is, for example, a linear motor, and moves the recoater 513 along a substantially horizontal travel direction from the material supply unit 514 to the additive manufacturing unit 515.

A laser light source that generates a light beam having an output of about several W to several kW can be used as the light beam source 501. The light beam source 501 of the additive manufacturing apparatus 5 of the present embodiment is a laser light source that generates a single mode fiber laser, that is, a laser having energy intensity of Gaussian distribution. In addition, the light beam source 501 also includes a galvano scanner for scanning the light beam over the powder bed.

Here, the light beam includes a laser beam and an electron beam, and further includes various beams capable of melting the metal powder. In addition, various lasers such as a laser having a near-infrared wavelength, a CO₂ laser (far-infrared laser), and a semiconductor laser can be applied as the laser beam, and the laser beam is appropriately determined in accordance with a type of target metal powder.

The control unit 530 is formed by a microcontroller or firmware. The control unit 530 includes a processing device such as a CPU, a storage device such as a random access memory (RAM) and a read only memory (ROM), and an input and output unit that exchanges programs and data stored in the storage device and signals with each unit of the additive manufacturing apparatus 5. The control unit 530 controls the gas supply unit 511, the exhaust mechanism 512, the material supply unit 514, the additive manufacturing unit 515, and the light beam source 501 by executing the programs stored in the storage device by the processing device. In addition, the detection results of the temperature sensor 56, the pressure sensor 57, and the oxygen sensor 58, the output of the camera, and the like are input to the control unit 530.

### <<Standard Sample for Searching for Additive Manufacturing Conditions in Powder Bed Fusion>>

Next, a standard sample used to search for additive manufacturing conditions of powder bed fusion will be described.

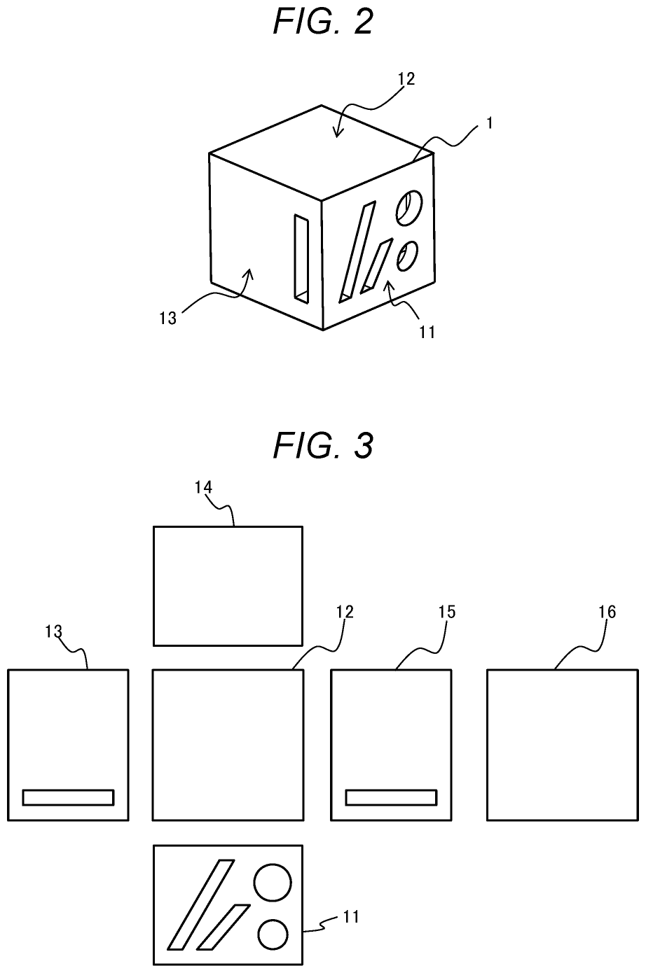

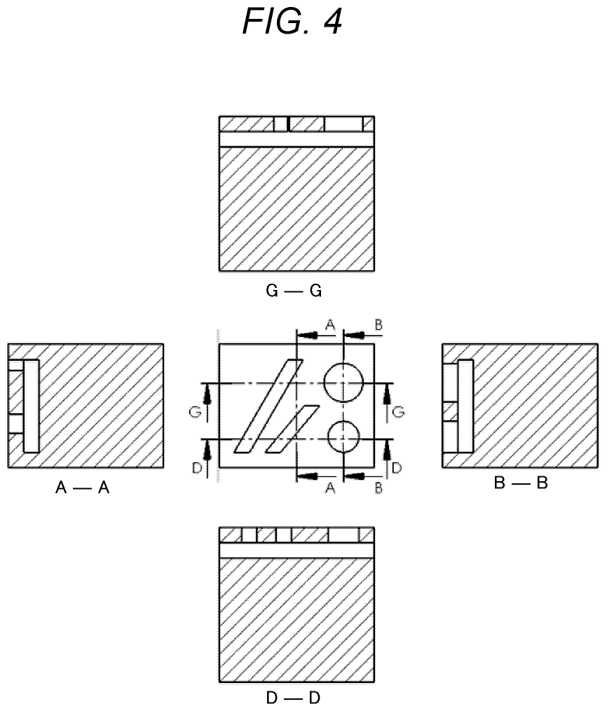

FIG. 2 is a schematic diagram illustrating an example of a shape of a standard sample 1. FIG. 3 is a developed view illustrating an example of the shape of the standard sample 1. FIG. 4 is a sectional view illustrating an example of the shape of the standard sample 1.

The standard sample 1 has a block shape of a hexahedron as a whole, and three surfaces of a bottom surface 16, an upper surface 12, and a back surface 14 are smooth surfaces. Rectangular punched pits are formed in a left side surface 13 and a right side surface 15. A front surface 11 has a parallelogram shape and a circular punched pit shape. That is, the front surface 11 is one surface in which punched pit shapes constituted by straight lines and curved lines are aggregated.

As illustrated in FIG. 4, the standard sample 1 includes two or more independent regions in a D-D section and a G-G section obtained by cutting out any one layer at a central portion in a stacking direction. These two or more regions are divided into a small region cut at a predetermined width from an outer edge of the standard sample 1 and a large region including other portions.

For example, a case where a process window under a condition of “In-skin”, which is a filling region of a modeling region with a simple block shape, is derived, and the additive manufacturing apparatus 5 models a fine shape within this range is considered. In a region having a small area, heat is likely to be accumulated and an overmolten state is caused, and deformation such as swelling of the shape occurs. When the additive manufacturing apparatus 5 spreads powder of a next layer, the modeled object and a squeegee may come into contact with each other and stop, or the modeled object may be destroyed.

When the additive manufacturing conditions are searched by using the standard sample 1 having the shape described above, it is possible to derive a condition that can be handled even for a modeled object having a different modeled area, particularly a modeled object including a small region, in advance.

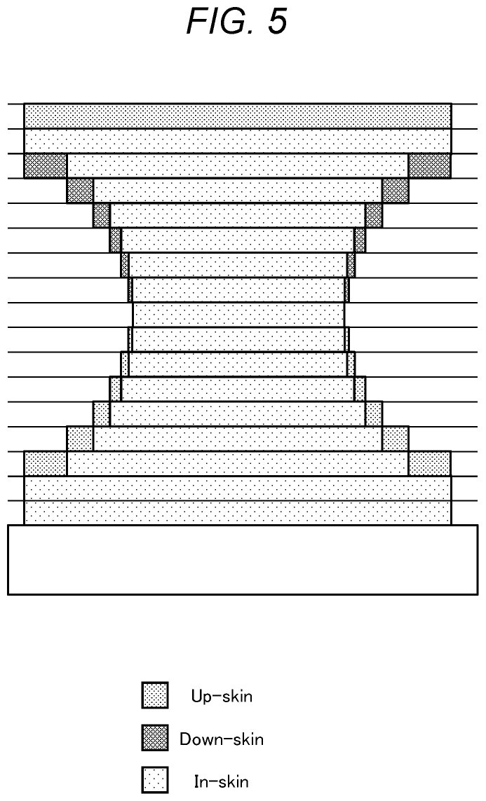

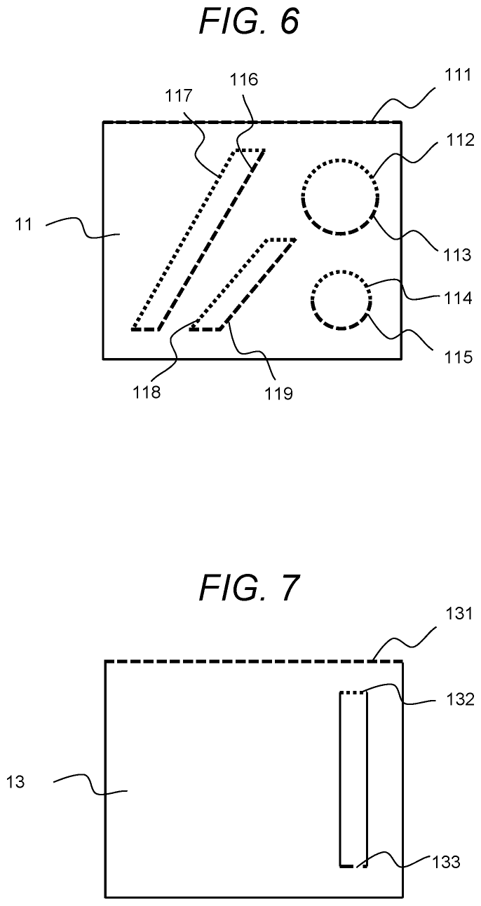

FIG. 5 is a diagram illustrating three types of regions of a section of the standard sample 1. FIG. 6 is a schematic diagram of the front surface 11 of the standard sample 1. FIG. 7 is a schematic diagram of the left side surface 13 of the standard sample 1.

The front surface 11 of FIG. 6 has a region 111 which is an upper end, a region 117 which is an upper side of a large parallelogram pit, and a region 116 which is a lower side. The front surface 11 has a region 118 on an upper side of a small parallelogram pit and a region 119 which is a lower side. The front surface 11 has a region 112 which is an upper side of a large circular pit and a region 113 which is a lower side. The front surface 11 has a region 114 which is an upper side of a small circular pit and a region 115 which is a lower side.

The regions 111, 116, 119, 113, and 115 are “Up-skin” that forms an outermost surface in a modeling height direction. The regions 117, 118, 112, and 114 area “Down-skin” that forms an overhang. The other regions are “In-skin”, which is the filling region of the modeling region, and is a region to be a base for forming the modeled object.

The left side surface 13 of FIG. 7 has a region 131 which is an upper end, a region 132 which is an upper side of a rectangular pit, and a region 133 which is a lower side. The regions 131 and 133 are “Up-skin” that forms an outermost surface in the modeling height direction. The region 132 is a “Down-skin” that forms an overhang.

In the “Down-skin” that forms the overhang, in a case where a three-dimensional shape is formed into slice data for each stacking thickness, any slice data is compared with slice data of one layer (or a plurality of layers) before the slice data, and there is no modeling region in the slice data of one layer (or a plurality of layers) before the slice data. Accordingly, the “Down-skin” sets a condition different from the “In-skin” that is the filling region of the modeling region in a case where there is the modeling region in any slice data.

When powder is irradiated with a beam, in a case where there is no material to be bonded to the melted powder and in a case where heat cannot be dissipated quickly due to heat conduction, the melted powder shrinks into a spherical shape to form a relatively large spherical lump on the powder. This phenomenon is referred to as boring, but when boring occurs, a surface state of an overhang portion deteriorates, and a bored lump is carried at the time of powder laying. Accordingly, there is nothing. Thus, in the “Down-skin” that forms the overhang, a condition for suppressing energy is selected.

In the “Up-skin” that forms the outermost surface in the modeling height direction, in a case where a three-dimensional shape is formed into slice data for each staking thickness, any slice data is compared with slice data after one layer (or a plurality of layers) of the slice data, and there is no modeling region in the slice data after one layer (or a plurality of layers). Accordingly, in the “Up-skin”, a condition different from the filling of the modeling region is set in a case where there is the modeling region in any slice data.

In the related art, after the process window of the filling condition of a modeling region is set with the simple block shape, conditions of “Down-skin” that forms an overhang with an inclined-shaped sample and “Up-skin” that forms an outermost surface in the modeling height direction are selected. However, conditions for constructing these three types of regions are modeled while being influenced by each. Thus, an action changes at a portion having a different modeling area. Accordingly, evaluation is performed in a shape in which each construction condition acts as in the standard sample 1, and thus, it is possible to approach an appropriate additive manufacturing condition. Further, machine learning is utilized, and thus, it is possible to quickly reach an appropriate additive manufacturing condition. That is, efficiency and/or accuracy of searching for an optimal solution of the additive manufacturing conditions of the additive manufacturing apparatus can be improved.

In the standard sample 1, portions for evaluating shape reproducibility are aggregated on the front surface 11. Accordingly, in the inspection of the standard sample 1, an image of the front surface 11 or displacement data may be acquired. When surface roughness and an internal defect rate are measured in a large area region, even though the shape reproducibility deteriorates (the shape is disturbed and broken), the influence on the surface roughness and the internal defect rate is small. Thus, each evaluation item can be accurately and easily measured. Further, a modeling difficulty level can be changed by changing an angle and a width of a parallelogram and a diameter of a circle.

### <<Measurement of Additive Manufacturing Conditions and Modeling Result of Standard Sample>>

In the present embodiment, an example in which data sets of several tens of additive manufacturing conditions are created by changing several tens of control factors and the standard sample 1 is additively manufactured by the additive manufacturing apparatus 5 will be described.

Here, the control factors are scale correction in x, y, and z directions, an offset amount from a contour line on CAD data for irradiating a contour line, an output and a scanning speed of a light beam with which the contour line is irradiated, an offset amount from a contour line irradiation position, a scanning line interval, a scanning pattern, a scanning line length, an offset amount between scanning patterns, and an output and a scanning speed of the light beam in the “In-skin” which is the filling region of the modeling region, an offset amount from a contour line irradiation position, a scanning line interval, a scanning pattern, a scanning line length, an offset amount between scanning patterns, and an output and a scanning speed of the light beam in the “Down-skin” that forms the overhang, an offset amount from a contour line irradiation position, presence or absence of double irradiation, a scanning line interval, and an output and a scanning speed of the light beam in the “Up-skin” that forms the outermost surface in the modeling height direction. However, the above control factors are merely examples, and are not intended to limit the technical scope of the present invention only to the control factors.

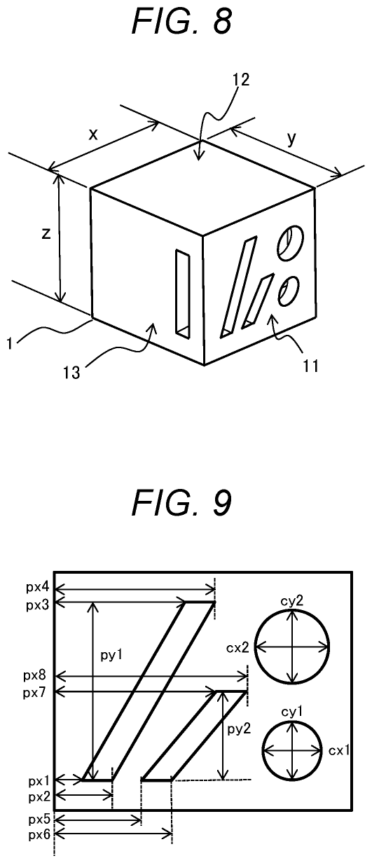

FIGS. 8 to 10 are diagrams illustrating examples of a method for measuring the additively manufactured standard sample 1.

FIG. 8 illustrates measurement portions of a total height Z, a width X, and a width Y of the sample as a modeling result of a shape of the additively manufactured standard sample 1.

In this measurement method, roughness of the left side surface 13 and the right side surface 15 (not illustrated) and the roughness of the upper surface 12 are measured. Here, the roughness of each surface is represented by an arithmetic average roughness Ra, a maximum height Ry, and a ten-point average roughness Rz.

As illustrated in FIG. 9, in this measurement method, an average dimensional error of dimensions px1 to px4 in a width direction and an average dimensional error of a dimension py1 in a height direction of a larger parallelogram punched pit are measured. In this measurement method, an average dimensional error of dimensions px5 to px8 in a width direction and ab average dimensional error of a dimension py2 in a height direction of a smaller parallelogram punched pit are measured.

An average dimensional error of a dimension cx2 in a width direction and an average dimensional error of a dimension cy2 in a height direction of a larger circular punched pit are measured. An average dimensional error of a dimension cx1 in a width direction and an average dimensional error of a dimension cy1 in a height direction of a smaller circular punched pit are measured. The above measurement results, a degree of damage of a parallelogram and a degree of damage of a circular shape were visually determined, and the degrees of damage were evaluated by numerical values from 0 to 3, with the degree of damage being 0 when shape reproduction accuracy was high and 3 when the shape was poor such as broken.

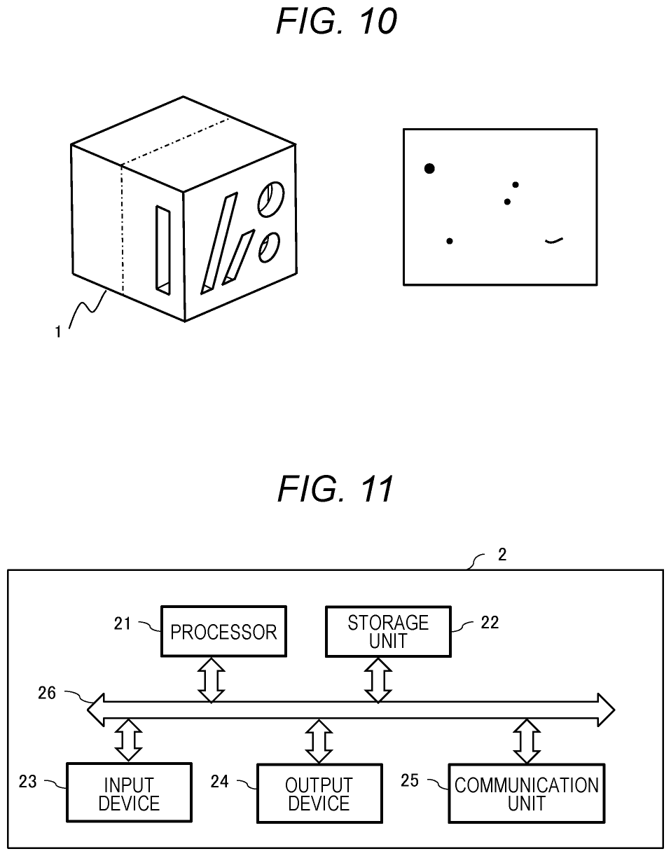

FIG. 10 illustrates defects when the standard sample 1 is cut in a section. The section is observed in this manner, and a sectional defect rate is measured.

### <<Measurement Examples of Additive Manufacturing Condition and Standard Sample Modeling Result>>

In addition to the sample evaluation method described above, an additive manufacturing condition search device 2 of the present embodiment compares monitoring information for extracting intensity of a specific wavelength when the powder is irradiated with the laser at the time of additive manufacturing with an X-ray CT result of the modeled object, and acquires a correlation between the intensity of the specific wavelength and the defect. Then, the additive manufacturing condition search device 2 performs defect determination of the modeled object by a second machine learning unit by using a database that has acquired the correlation between the intensity of the specific wavelength and the defect, and measures the result as the defect rate. In addition, the additive manufacturing condition search device 2 of the present embodiment performs shape measurement during modeling using intensity data of a specific wavelength and image data by an optical camera, three-dimensionally expresses the shape measurement, and acquires the shape measurement as the modeling result of the standard sample 1.

FIG. 11 is a block diagram illustrating a hardware configuration example of the additive manufacturing condition search device 2.

The additive manufacturing condition search device 2 searches a search region for a value of an input parameter to be a solution. The additive manufacturing condition search device 2 includes a processor 21, a storage unit 22, an input device 23, an output device 24, and a communication unit 25. The processor 21, the storage unit 22, the input device 23, the output device 24, and the communication unit 25 are connected by a bus 26. The processor 21 controls the additive manufacturing condition search device 2. The storage unit 22 is a work area of the processor 21.

The storage unit 22 is a non-transitory or transitory recording medium that stores various programs and data. Examples of the storage unit 22 include a ROM, a RAM, a hard disk drive (HDD), and a flash memory.

The input device 23 inputs data. Examples of the input device 23 include a keyboard, a mouse, a touch panel, a numeric keypad, and a scanner.

The output device 24 outputs data. Examples of the output device 24 include a display and a printer.

The communication unit 25 is connected to a network to transmit and receive data. Examples of the communication unit 25 include a network interface.

### <<Functional Configuration Example of Additive Manufacturing Condition Search Device 2>>

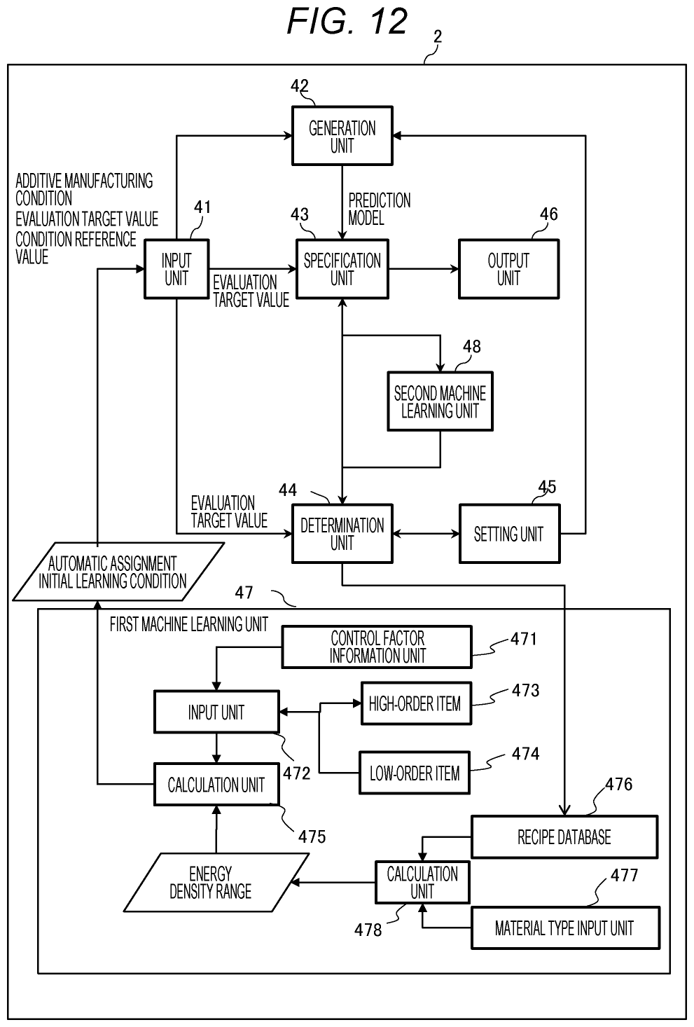

FIG. 12 is a block diagram illustrating a functional configuration example of the search device.

The additive manufacturing condition search device 2 includes a first machine learning unit 47, an input unit 41, a generation unit 42, a specification unit 43, a second machine learning unit 48, a determination unit 44, a setting unit 45, and an output unit 46. The first machine learning unit 47, the input unit 41, the generation unit 42, the specification unit 43, the determination unit 44, the setting unit 45, and the output unit 46 are embodied by the processor 21 executing the programs stored in the storage unit 22. The additive manufacturing condition search device performs the additive manufacturing condition search method.

The first machine learning unit 47 includes a control factor information unit 471, an input unit 472, a high-order item 473, a low-order item 474, calculation units 475 and 478, a recipe database 476, and a material type input unit 477. The first machine learning unit 47 outputs the automatically assigned initial learning condition to the input unit 41. The first machine learning unit 47 outputs additive manufacturing conditions corresponding to material information and device information.

The control factor information unit 471 is a storage unit that stores the control factors of the additive manufacturing apparatus 5. Note that, the control factor information unit 471 may receive selection of the control factor of the additive manufacturing apparatus 5 and input of a setting range of the control factor.

The input unit 472 assigns the high-order item 473, the low-order item 474, and a setting order to the control factors of the additive manufacturing apparatus 5 input from the control factor information unit 471, and outputs the control factors to the calculation unit 475.

The recipe database 476 accumulates material types, material physical properties, and modeling conditions and manufacturing results for each material performed in the past in association with each other. The manufacturing result includes the monitoring information and the defect information. When the monitoring information is acquired from the recipe database 476 and attribute information of each material type is acquired from the material type input unit 477, the calculation unit 478 calculates a setting range of an energy density and outputs the setting range to the calculation unit 475. The material type input unit 477 receives input of the material type and material physical properties by a user operation. The material type input unit 477 is a storage unit that stores the material type and the material physical properties thereof, and the calculation unit 478 may acquire the material type and the material physical properties thereof from the material type input unit 477.

The calculation unit 475 calculates the additive manufacturing conditions based on the control factors of the additive manufacturing apparatus 5 and the setting range of the energy density, and outputs the additive manufacturing conditions to the input unit 41. Note that, the first machine learning unit 47 outputs an initial recipe that is the automatically assigned initial learning condition.

The input unit 41 receives the additive manufacturing conditions set in the additive manufacturing apparatus 5 from the first machine learning unit 47, and receives input of an evaluation target value and a condition reference value by a user operation. The additive manufacturing conditions set in the additive manufacturing apparatus 5 are the above-described input parameters.

Specifically, the input parameters are scale correction in x, y, and z directions, an offset amount from a contour line on CAD data for irradiating a contour line, an output and a scanning speed of a light beam with which the contour line is irradiated, an offset amount from a contour line irradiation position, a scanning line interval, a scanning pattern, a scanning line length, an offset amount between scanning patterns, and an output and a scanning speed of the light beam in the “In-skin” which is the filling region of the modeling region, an offset amount from a contour line irradiation position, a scanning line interval, a scanning pattern, a scanning line length, an offset amount between scanning patterns, and an output and a scanning speed of the light beam in the “Down-skin” that forms the overhang, an offset amount from a contour line irradiation position, presence or absence of double irradiation, a scanning line interval, and an output and a scanning speed of the light beam in the “Up-skin” that forms the outermost surface in the modeling height direction.

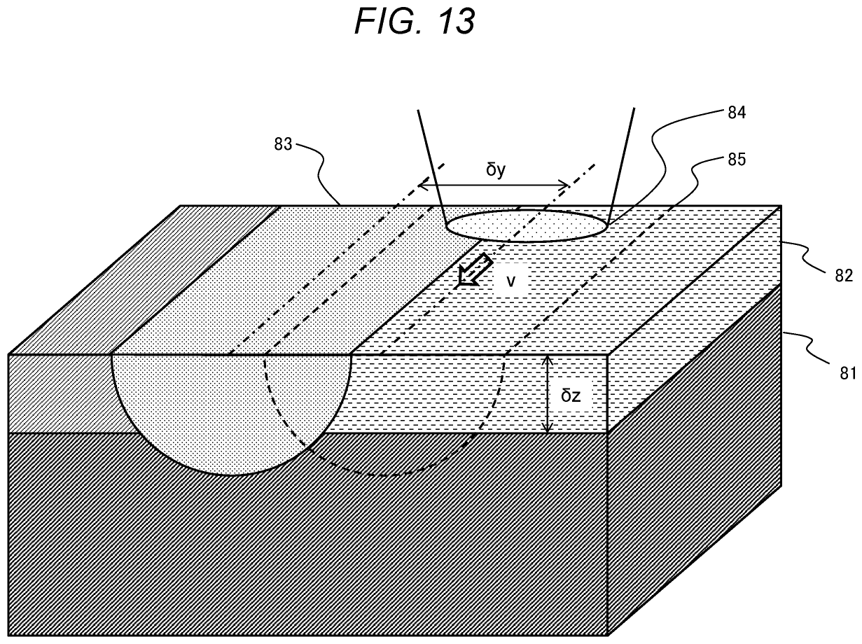

FIG. 13 is an explanatory diagram illustrating a scanning line interval among the input parameters.

A powder bed 82 illustrates an uppermost layer, and a thickness thereof is oz. A powder bed 81 is a layer lower than the uppermost layer and has been laid in the past. A scanning line 83 is a portion irradiated in previous scanning. A scanning line 85 is a portion scheduled to be irradiated in current scanning. Then, a beam spot 84 is a portion being currently irradiated. An interval between the scanning line 83 and the scanning line 85 is oy.

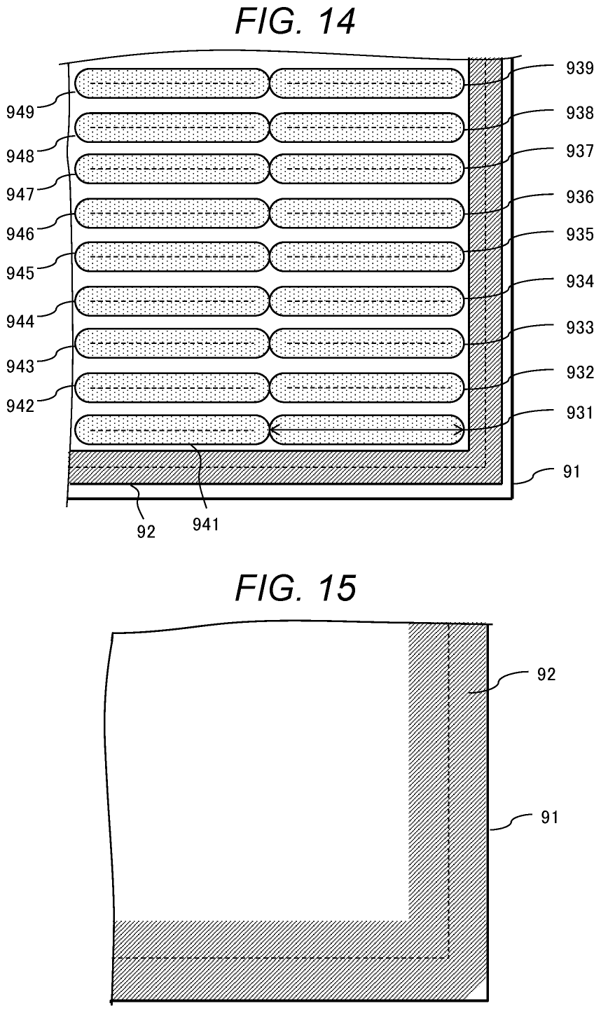

FIG. 14 is an explanatory diagram of the scanning line interval, the scanning pattern, the scanning line length, and the offset amount between the scanning patterns.

A contour line irradiation region 92 is an irradiation region that forms a contour of the modeled object, and a plurality of scanning lines 931 to 939, scanning lines 941 to 949, and the like are drawn to fill the inside thereof. Accordingly, a molten pool can be formed to fill an inside of the modeled object.

FIG. 15 is an explanatory diagram of an offset amount from contour line irradiation.

A contour line 91 is a contour of the modeled object on the CAD data. The contour line irradiation region 92 is irradiated inward by a predetermined offset amount from the contour line 91. Accordingly, it is possible to form a contour with a less error in consideration of a size of the molten pool due to the light beam.

Referring back to FIG. 12, the description will be continued. The input unit 41 receives input of the evaluation target t value that is a target value of the modeling result additively manufactured by the additive manufacturing apparatus 5.

An actual measurement value of the modeling result additively manufactured by the additive manufacturing apparatus 5 is the above-described output parameter. The output parameter includes an actual measurement value of the modeling result of the standard sample 1 of the additive manufacturing by the additive manufacturing apparatus 5 and an actual measurement value regarding an apparatus state of the additive manufacturing apparatus 5.

In addition, the input unit 41 receives input of an inside of the search region defined by a range of the additive manufacturing condition of the standard sample 1, which is an input parameter, and a range of the actual measurement value of the modeling result of the standard sample 1, which is an output parameter, and a reference value of the additive manufacturing condition of the search region. The search region is a region for searching for a value of the input parameter, and specifically, is an input range that can be set as the control factor of the additive manufacturing condition. The search region is defined by a control range of the input parameter and a target range of the output parameter of the additive manufacturing apparatus 5. The reference value of the additive manufacturing condition is a reference value of the input parameter, and is a value of an input parameter obtained in the past.

The generation unit 42 generates a prediction model indicating a relationship between the additive manufacturing condition and the actual measurement value of the manufacturing result based on a combination of the setting value of the additive manufacturing condition within the search region and the actual measurement value of the manufacturing result in a case where the setting value is given to the additive manufacturing apparatus 5. The setting value of the additive manufacturing condition is a value of an input parameter prepared as learning data. The actual measurement value of the modeling result is obtained by actually measuring the modeling result obtained by modeling the standard sample 1 by the additive manufacturing apparatus 5.

The prediction model is a function indicating a relationship between an input parameter and an output parameter. The generation unit 42 generates a prediction model indicating a relationship between the setting value of the condition within the search region and the actual measurement value of the output by statistical analysis such as regression analysis capable of coping with multiple-input and multiple-output such as a neural network and a support vector machine, correlation analysis, principal component analysis, or multiple regression analysis.

The specification unit 43 specifies a presence region of a prediction value from the prediction model by giving the evaluation target value input by the input unit 41 to the prediction model generated by the generation unit 42. The specification unit 43 further performs a verification experiment of setting this prediction value in the additive manufacturing apparatus 5 to model the standard sample 1, acquires monitoring information during modeling, and acquires the result as the actual measurement value. Here, the actual measurement value is shape information and defect information acquired by the specification unit 43 by inspecting the modeled object. The determination unit 44 determines whether or not the actual measurement value that is the result of the verification experiment, that is, the defect information of the modeled object has achieved the evaluation target value.

The second machine learning unit 48 estimates a modeling result score, which is a defect determination result of the modeled standard sample 1, from monitoring information acquired in the verification experiment in which the standard sample 1 is modeled by setting the prediction value in the additive manufacturing apparatus 5. Here, the modeling result score is the actual measurement value that is the result of the verification experiment, and is also the defect information of the modeled object.

In a case where the determination unit 44 determines that the actual measurement value that is the result of the verification experiment of the prediction value has not achieved the evaluation target value, the setting unit 45 adds the combination of the prediction value and the actual measurement value to the combination of the setting value of the additive manufacturing condition and the modeling result, and causes the generation unit 42 to update the prediction model.

In a case where the determination unit 44 determines that the actual measurement value which is the result of the verification experiment of the prediction value has achieved the evaluation target value, the output unit 46 outputs the prediction value. The output unit 46 may display the prediction value that has achieved the evaluation target value on a display that is an example of the output device 24, may transmit the prediction value to an external device via the communication unit 25, or may store the prediction value in the storage unit 22 or the recipe database 476. This prediction value is a setting value of the additive manufacturing condition.

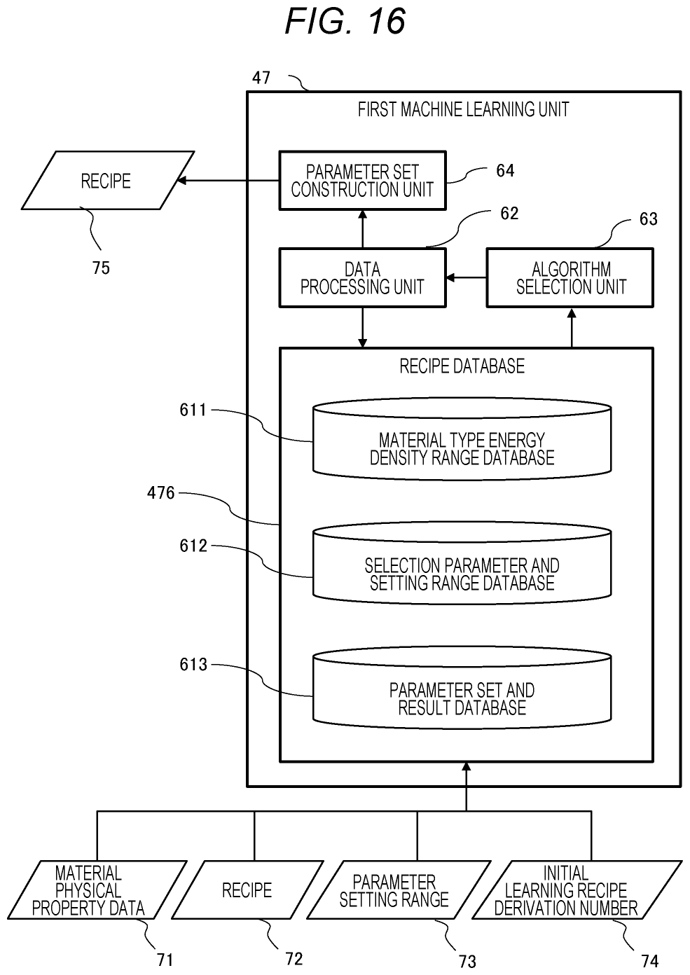

FIG. 16 is a block diagram illustrating a functional configuration example of the first machine learning unit 47.

The first machine learning unit 47 includes a recipe database 476, a data processing unit 62, an algorithm selection unit 63, and a parameter set construction unit 64. The recipe database 476 stores a material type energy density range database 611, a selection parameter and setting range database 612, and a parameter set and result database 613.

The first machine learning unit 47 outputs, as an initial learning recipe, the additive manufacturing condition corresponding to the material information and the device information. Then, the first machine learning unit 47 outputs a new additive manufacturing condition as a recommended recipe from a combination of a plurality of additive manufacturing conditions and defect information. The recipe database 476 stores material types, material physical properties, and additive manufacturing conditions and manufacturing results for each material performed in the past.

The material type energy density range database 611 stores a material type, material physical properties, and characteristics of the modeled object when a predetermined energy density is applied to the material. The selection parameter and setting range database 612 stores parameters, setting ranges, and the like selected by the user. The parameter set and result database 613 stores additive manufacturing conditions and manufacturing results for each material performed in the past. The manufacturing result refers to defect information of an additively manufactured modeled object under this additive manufacturing condition.

When material physical property data 71, a recipe 72, a parameter setting range 73, and an initial learning recipe derivation number 74 are input to the first machine learning unit 47, various kinds of machine learning are performed based on the recipe database 476, and then a recipe 75 that is the additive manufacturing condition is calculated. The recipe 75 includes a heat source output, a scanning speed, a scanning line interval, and a stacking thickness, which are control factors for filling the inside of the modeled object. The first machine learning unit 47 calculates the setting range of the energy density from the control factors for filling the inside of the modeled object, and assigns an additive manufacturing condition for initial learning in accordance with the setting range of the energy density. The first machine learning unit 47 receives selection of these control factors and input of setting ranges of the control factors, and assigns the high-order item, the low-order item, and the setting order to these control factors.

The material physical property data 71 is a combination of the material type and the material physical property. The recipe 72 is a parameter group indicating the additive manufacturing condition, and refers to, for example, a laser output or an operation speed in In-Skin, Down-Skin, or contour.

The algorithm selection unit 63 constructs calculation rules such as a parameter determination rule, an energy density calculation, an automatic assignment rule, and a pass and fail determination rule in accordance with items to be set, and provides the calculation rules to the data processing unit 62. When a parameter set is obtained by a calculation corresponding to the calculation rule given from the algorithm selection unit 63, the data processing unit 62 outputs the parameter set to the parameter set construction unit 64. The parameter set construction unit 64 derives the recipe 75 which is the initial learning recipe corresponding to a necessary unit from the parameter set calculated by the data processing unit 62.

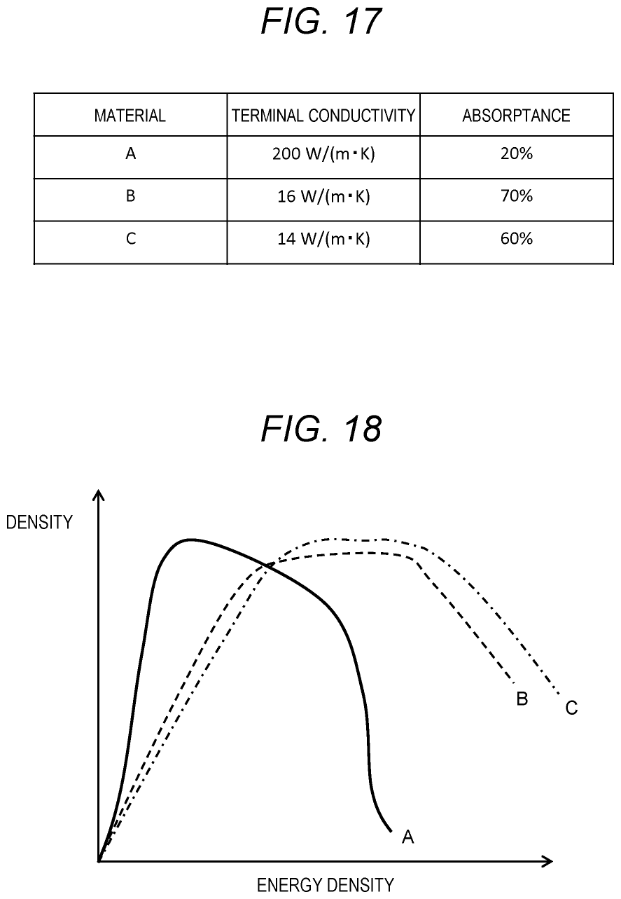

FIG. 17 is a diagram illustrating physical property values of materials.

The material physical property data 71 stores a combination of each material name and physical property data such as thermal conductivity and absorptance.

FIG. 18 is a graph representing a relationship between a defect value and an energy density of each material.

A horizontal axis of the graph represents the energy density. A vertical axis represents the density of the additively manufactured product. The higher the density of the additively manufactured product, the lower the defect rate. It is necessary to set the additive manufacturing conditions at an appropriate energy density such that the density of the additively manufactured product exceeds a predetermined value for each of materials A to C.

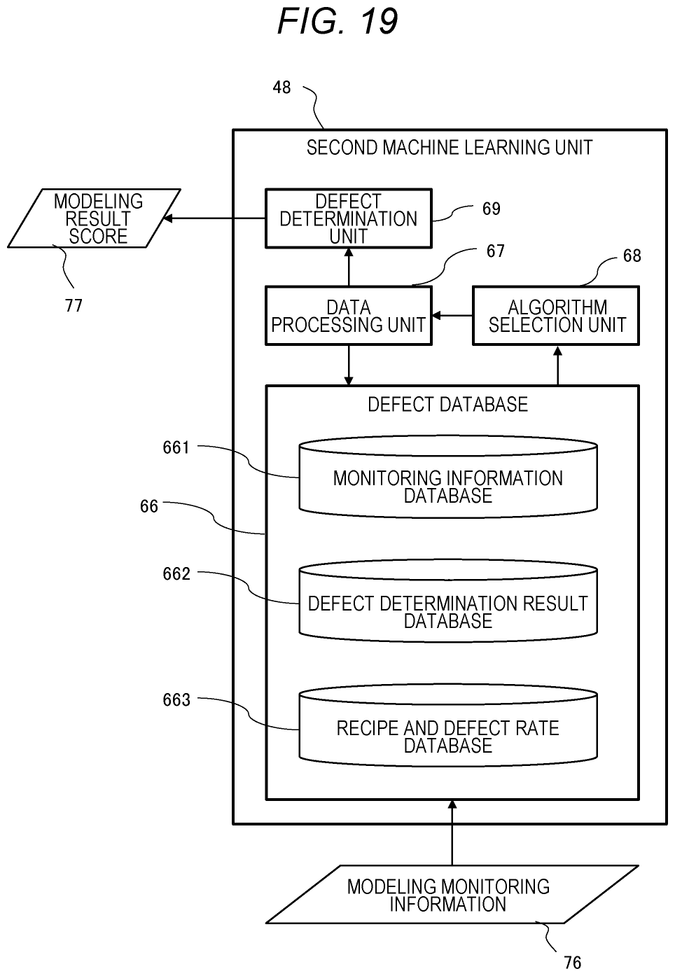

FIG. 19 is a block diagram illustrating a functional configuration example of the second machine learning unit 48.

The second machine learning unit 48 includes a defect database 66, a data processing unit 67, an algorithm selection unit 68, and a defect determination unit 69. The defect database 66 stores a monitoring information database 661, a defect determination result database 662, and a recipe and defect rate database 663. The second machine learning unit 48 is a portion that calculates a modeling result score 77 from monitoring information 76 acquired from the additive manufacturing apparatus 5 during modeling. Accordingly, a score of the modeling result can be obtained without manually measuring the modeled object such as the standard sample 1. Note that, the monitoring information 76 includes brightness, temperature, wavelength, optical image, and the like of a laser irradiation unit during modeling. In the second machine learning unit 48, a model trained by using the defect database as train data estimates the defect information of the modeled object from the monitoring information during modeling. Then, the second machine learning unit 48 stores the defect information of the modeled object, the material, the shape information, the additive manufacturing condition, and the monitoring information during modeling in the defect database.

The monitoring information database 661 stores monitoring information during past modeling. The defect determination result database 662 stores a defect determination result by manual work or the like of the standard sample 1 modeled when the monitoring information is acquired. The recipe and defect rate database 663 stores each recipe (additive manufacturing condition) and a defect determination rate in association with each other. That is, the defect database 66 accumulates materials, shape information, additive manufacturing conditions, monitoring information during modeling, and defect information in association with each other.

The data processing unit 67 performs machine learning by using, as train data, past monitoring information of the monitoring information database 661 and a past defect determination result of the defect determination result database 662, and creates a model that predicts the defect determination result in a case where the monitoring information is used as an input. The algorithm selection unit 68 selects an algorithm for creating a correlation map between the monitoring information and the defect determination result and provides the algorithm to the data processing unit 67.

The defect determination unit 69 determines a defect from the monitoring information 76 according to the model generated by the data processing unit 67, and derives the modeling result score 77.

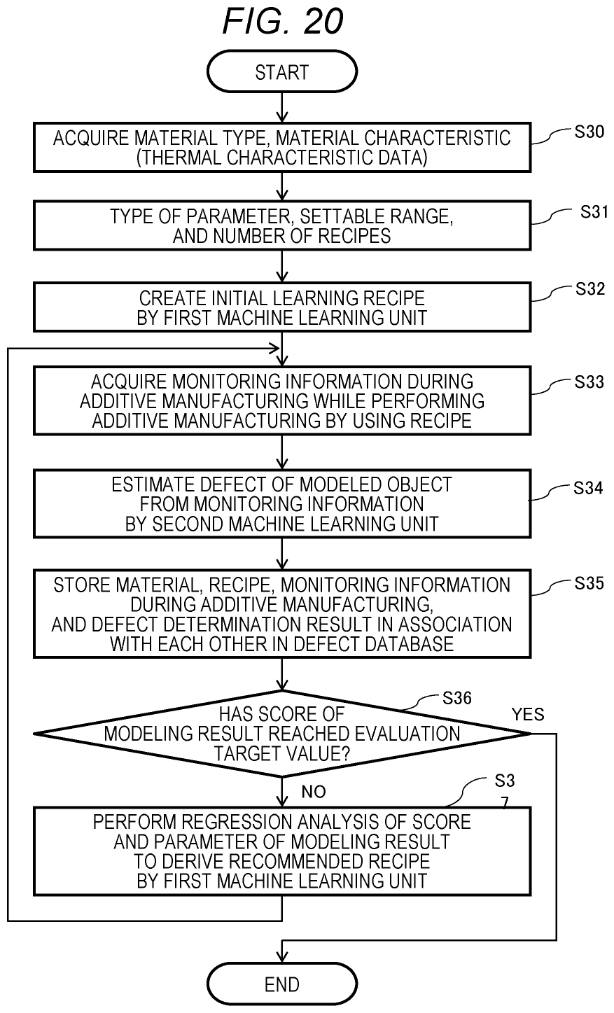

FIG. 20 is a flowchart illustrating the search processing by the additive manufacturing condition search device 2.

First, the first machine learning unit 47 acquires a material type and a material characteristic (thermal characteristic data) by the material type input unit 477 (step S30). Then, the first machine learning unit 47 acquires a type of the parameter, a settable range, and the number of recipes by the input unit 472 (step S31). Here, the recipe refers to the additive manufacturing condition corresponding to the material information and the device information.

The first machine learning unit 47 creates an initial learning recipe for the new modeling condition by the calculation unit 475 (step S32).

The additive manufacturing apparatus 5 acquires monitoring information during additive manufacturing while additively manufacturing the modeled object by using this recipe (step S33). Then, the second machine learning unit 48 estimates a defect of the modeled object from the monitoring information (step S34). Note that, in parallel with step S34, an inspector may inspect the modeled object manufactured by the additive manufacturing apparatus 5 to acquire the shape information and the defect information of the modeled object.

Then, the determination unit 44 stores the material when the modeled object is additively manufactured, the recipe, the monitoring information during additive manufacturing, and the defect determination result in the recipe database 476 in association with each other (step S35).

In step S36, the determination unit 44 determines whether or not the score of the modeling result has reached the evaluation target value. When the score of the modeling result has reached the evaluation target value (Yes), the determination unit 44 ends the processing of FIG. 20. When the score of the modeling result has not reached the evaluation target value (No), the determination unit 44 proceeds to step S37.

In step S37, when the first machine learning unit 47 performs regression analysis of the score and the parameter of the modeling result to derive a new recommended recipe, the processing returns to step S33. Then, the additive manufacturing condition search device 2 repeats a series of processing from steps S33 to S36 based on the recommended recipe. Accordingly, the first machine learning unit 47 can correct the recommended recipe until the score reaches the evaluation target value.

### <<Search for Additive Manufacturing Condition>>

The search for the additive manufacturing condition is realized by performing a verification experiment based on a prediction model and searching for an optimal solution that satisfies a target. Thus, the additive manufacturing condition search device 2 adds the modeling result which is the result of the verification experiment to the learning data to update the prediction model, and repeatedly performs the update until the target is satisfied. The additive manufacturing condition search device 2 can further efficiently search for an optimal solution by gradually updating the target toward a final target.

In the additive manufacturing, the additive manufacturing condition search device 2 creates a data set of the predetermined number of additive manufacturing conditions described above. Then, the additive manufacturing condition search device 2 causes the additive manufacturing apparatus 5 to additively manufacture the standard sample 1, and generates the prediction model by using the verification experiment result (modeling result) as the learning data.

The additive manufacturing condition search device 2 generates the prediction model from the learning data to which the verification experiment result has been added, and calculates the prediction result by the prediction model. The verification experiment result (modeling result) obtained by using the production result calculated above as the additive manufacturing condition satisfies the target, it is possible to efficiently search for the optimal solution by repeating the above processing.

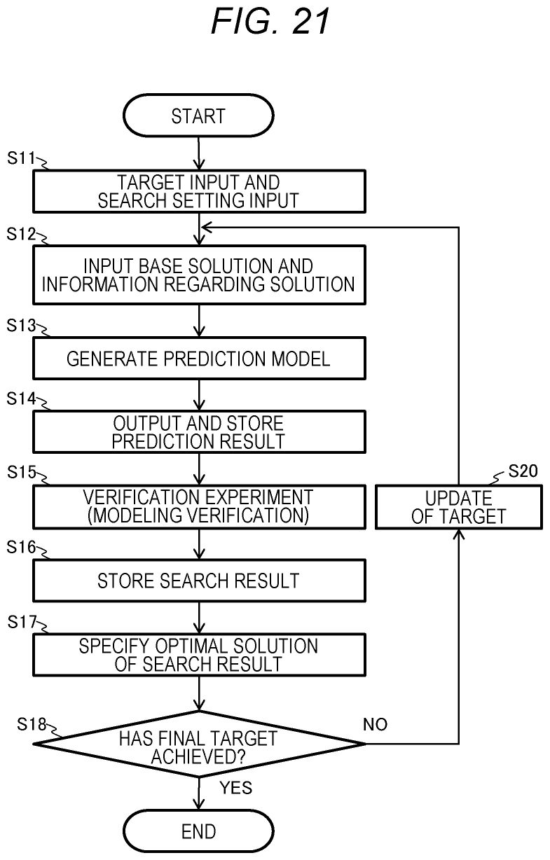

FIG. 21 is a flowchart of additive manufacturing condition search processing in the additive manufacturing apparatus 5.

The additive manufacturing condition search device 2 receives input of the target value of the modeling result of the standard sample 1 additively manufactured by the additive manufacturing apparatus 5 and a search setting (step S11). The search setting is, for example, an allowable value of a difference or a deviation between the search result and the target value.

Subsequently, the additive manufacturing condition search device 2 receives input of a base solution and input of information regarding the solution by the input unit 41 (step S12). Specifically, the additive manufacturing condition search device 2 receives input parameters of data sets of the above-described several tens of additive manufacturing conditions and output parameters when the input parameters are used. The additive manufacturing condition search device 2 further receives input of an optimal solution before the start of the search (value of the input parameter), an output parameter when the optimal solution is used, a target value of the output parameter before the start of the search, and a model function describing a relationship between the input parameter and the output parameter.

The additive manufacturing condition search device 2 causes the generation unit 42 to generate the prediction model for predicting the input parameter that is the solution that satisfies the target value of the modeling result of the standard sample 1 (step S13). Specifically, the additive manufacturing condition search device 2 generates, as the prediction model, a function indicating a relationship between pieces of input and output data of the additive manufacturing apparatus 5 by using data (for example, initial data) stored in the storage unit 22. The input and output data is a combination of the input data and the output data when the value of the input parameter given to the additive manufacturing apparatus 5 is used as the input data and the actual measurement value obtained from the modeling result of the standard sample 1 additively manufactured by the additive manufacturing apparatus 5 is used as the output data.

Note that, as a method for analyzing the relationship between the pieces of input and output data, regression analysis capable of coping with multiple-input and multiple-output such as neural network, support vector regression, and regression using a kernel method can be used. In addition, statistical analysis such as correlation analysis, principal component analysis, and multiple regression analysis can be used.

Subsequently, the additive manufacturing condition search device 2 predicts a parameter of an additive manufacturing condition for obtaining a target solution or obtaining a modeling result close to the target solution by using the generated prediction model, and outputs and stores the parameter as a prediction result (step S14).

In order to search for the optimal solution by one prediction, it is necessary to acquire and analyze data covering the entire region of the parameter setting range that can be set under the additive manufacturing conditions. However, as described above, since the combination of the parameters becomes enormous as the number of parameters increases, a search time becomes enormous in the search of the entire region, and it becomes extremely difficult to perform the search.

In order to efficiently search for a solution while avoiding these problems, prediction and verification may be repeated by (a) acquiring data for creating a prediction model, (b) creating a prediction model, (c) acquiring a prediction result, (d) performing the verification experiment of the prediction result, and (a2) adding the verification experiment result to the database for model creation.

The acquisition of the data for creating the prediction model corresponds to the processing of step S12. The generation of the prediction model corresponds to the processing of step S13. The acquisition of the prediction result corresponds to the processing of step S14. The verification experiment of the prediction result corresponds to the processing of step S15. The addition of the verification experiment result to the database for model creation corresponds to the processing of step S16.

Specifically, the additive manufacturing condition search device 2 performs the verification experiment by the additive manufacturing apparatus 5 with the prediction condition as the search condition (step S15). Then, the additive manufacturing condition search device 2 acquires the input and output data of the additive manufacturing apparatus 5 under each search condition, as the verification experiment result, that is, the search result.

The additive manufacturing condition search device 2 stores the acquired search result in the recipe and defect rate database 663 (step S16). That is, the additive manufacturing condition search device 2 stores, as the search result, input and output data which is a set of a value of the additive manufacturing condition which is the input parameter used in the verification experiment and a value of the modeling result of the standard sample 1 additively manufactured by the additive manufacturing apparatus 5 acquired by using the value of the input parameter, in the recipe and defect rate database 663. Here, the value of the modeling result of the standard sample 1 is the defect information of the standard sample 1.

Subsequently, the additive manufacturing condition search device 2 specifies the optimal solution from the acquired input and output data (step S17), and stores the specified optimal solution in the storage unit 22.

Then, the additive manufacturing condition search device 2 determines whether or not the final target has been achieved (step S18). In a case where the final target has been achieved (step S18: Yes), the additive manufacturing condition search device 2 ends the processing of FIG. 21. On the other hand, in a case where the final target has not been achieved (step S18: No), the additive manufacturing condition search device 2 proceeds to step S20 to update the target, and then returns to step S12 to update the learning data.

Specifically, in step S18, in a case where the output parameter corresponding to the updated optimal solution is equal to the final target value or a difference from the final target value is within an allowable range, the additive manufacturing condition search device 2 determines that the final target has been achieved (step S18: Yes).

On the other hand, in a case where the output parameter corresponding to the updated optimal solution is equal to the final target value or the difference from the final target value is not within the allowable range, the additive manufacturing condition search device 2 determines that the target has not been achieved (step S18: No), and proceeds to step S20.

In step S20, the additive manufacturing condition search device 2 updates the target value, and the allowable value of the difference or deviation between the search result and the target value, and returns to the processing of step S12.

In a case where the final target is given from the beginning or a very small value is given as the allowable value of the difference or deviation between the search result and the target value when the processing proceeds from steps S13 to S18, a difficulty level of the optimal solution search increases, and there is a possibility that the additive manufacturing condition search device 2 cannot find the solution. To avoid this, the additive manufacturing condition search device 2 may give a target different from the final target at an initial stage of the search. In a case where a current target has been achieved and the final target has not been satisfied (step S18: No), in step S20, the target value is brought close to the final target value in a stepwise manner, and thus, a possibility that the solution for achieving the final target can be found can be increased.

In addition, in a case where the additive manufacturing condition search device 2 gives a large value as the allowable value of the difference or deviation between the search result and the target value as the current target, and the current target has been achieved and the final target has not been satisfied (step S18: No), the target value is brought close to the final target value in a stepwise manner, and thus, the additive manufacturing condition search device 2 can increase the possibility that the solution for achieving the final target can be found.

As the stepwise update method from the initial target to the final target, a plurality of target values having values between the initial target and the final target may be prepared, the initial target may be given as the initial current target, and a target value approaching the final target may be updated as a current target value whenever the current target has been achieved. Alternatively, the initial target value may be given as the first current target, and the plurality of target values may be prepared and used to gradually approach the final target at a predetermined ratio.

### Second Embodiment

In the additive manufacturing condition search of the first embodiment, when the standard sample is used, the number of modeling conditions that can be disposed in a modelable region can be evaluated by one verification experiment.

On the other hand, in a case where parameters related to a modeling environment are handled, it is necessary to assign the modeling condition to each environment. The parameters related to the modeling environment include, for example, a stacking thickness, a preheating temperature, a modeling environmental pressure, a powder particle size, and the like. That is, in additive manufacturing, since the parameters related to the modeling environment cannot be changed by one verification experiment, it is necessary to change the data set of the additive manufacturing condition whenever the parameters related to the modeling environment are changed.

In a case where the parameters related to the modeling environment are changed, it is necessary to clarify the purpose. For example, it is necessary to clarify whether the purpose of the parameter change related to the modeling environment is optimization including the modeling condition and the parameter related to the modeling environment or determination of the parameter related to the modeling environment. For example, in the verification result of the present inventor, in a case where the additive manufacturing condition is searched by using the data set of the additive manufacturing condition including the stacking thickness, it becomes clear that the additive manufacturing condition search device 2 derives a condition in which the stacking thickness is thinner as the prediction value.

Thus, in a case where the stacking thickness is handled, it is preferable that a stacking thickness required by an engineer is determined in advance and is optimized, as a fixing condition, by the processing of FIG. 21. However, in a case where there is a predetermined deviation between the solution and the target value even though the solution is searched only for a predetermined development period, the optimal solution of the stacking thickness for the metal material can be obtained by changing the stacking thickness to a smaller stacking thickness and obtaining the optimal solution.

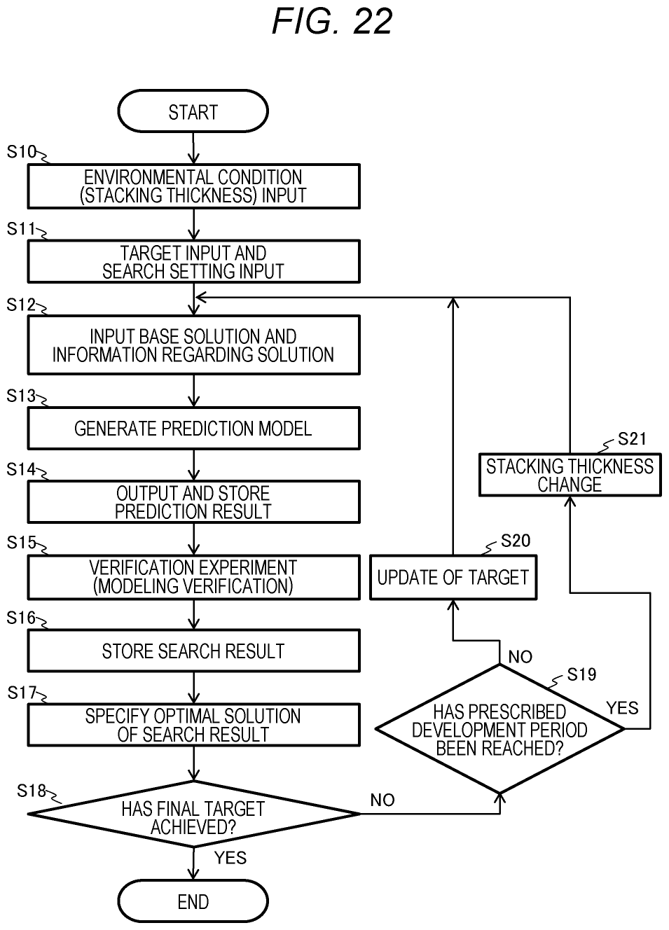

FIG. 22 is a flowchart of additive manufacturing condition search processing in the additive manufacturing condition search device 2 of a second embodiment.

First, the input unit 41 receives input of an environmental condition such as a stacking thickness (step S10), and proceeds to processing similar to step S11 in FIG. 21. The parameters related to the modeling environment may be obtained in advance by another method and then may be input to the additive manufacturing condition search device 2 of the second embodiment.

The processing from steps S11 to S17 is similar to the processing in FIG. 21.

In step S18, in a case where the output parameter corresponding to the updated optimal solution is equal to the final target value or the difference from the final target value is within the allowable range, the additive manufacturing condition search device 2 determines that the final target has been achieved (step S18: Yes).

On the other hand, in a case where the output parameter corresponding to the updated optimal solution is equal to the final target value or the difference from the final target value is not within the allowable range, the additive manufacturing condition search device 2 determines that the target has not been achieved (step S18: No), and proceeds to step S19.

In step S19, the additive manufacturing condition search device 2 determines whether or not a prescribed development time has been reached. When the prescribed development time has been reached (Yes), the additive manufacturing condition search device 2 proceeds to step S21, and when the stacking thickness is changed, the additive manufacturing condition search device 2 returns to step S12.

When the defined development time has not been reached (No), the additive manufacturing condition search device 2 proceeds to step S20, updates the target similarly to FIG. 21, and returns to step S12.

### (Modification)

The present invention is not limited to the aforementioned embodiments, and includes various modifications. For example, the aforementioned embodiments are described in detail in order to facilitate easy understanding of the present invention, and are not limited to necessarily include all the described components. Some of the components of a certain embodiment can be substituted into the components of another embodiment, and the components of another embodiment can be added to the component of a certain embodiment. In addition, the components of another embodiment can be added, removed, and substituted to, from, and into some of the components of the aforementioned embodiments.

A part or all of the aforementioned configurations, functions, processing units, and processing means may be realized by hardware such as an integrated circuit, for example. Each of the aforementioned configurations and functions may be realized by software by interpreting and executing a program that realizes each function by the processor. Information of programs, tables, files, and the like for realizing the functions can be stored in a recording device such as a memory, a hard disk, or a solid state drive (SSD), or a recording medium such as a flash memory card, or a digital versatile disk (DVD).

In each of the embodiments, control lines and information lines illustrate lines which are considered to be necessary for the description, and not all the control lines and information lines in a product are necessarily illustrated. Almost all the configurations may be considered to be actually connected to each other.

Examples of the modifications of the present invention include the following (a) to (c).
(a) The present invention is not limited to an additive manufacturing apparatus of a powder bed fusion system, and may be applied to a directed energy deposition system or other additive manufacturing apparatuses.
(b) The standard sample may have at least three smooth surfaces.
(c) The standard sample is not limited to a cubic shape, and may be a rectangular parallelepiped.

### REFERENCE SIGNS LIST

1 standard sample
11 front surface
111 to 119 region
12 upper surface
13 left side surface
131 to 133 region
14 back surface
15 right side surface
16 bottom surface
2 additive manufacturing condition search device
21 processor
22 storage unit
23 input device
24 output device
25 communication unit
26 bus
41 input unit
42 generation unit
43 specification unit
44 determination unit
45 setting unit
46 output unit
47 first machine learning unit
471 control factor information unit
472 input unit
473 high-order item
474 low-order item
475 calculation unit
476 recipe database
477 material type input unit
478 calculation unit
48 second machine learning unit
5 additive manufacturing apparatus
501 light beam source
502 transmission window
510 chamber
511 gas supply unit
512 exhaust mechanism
513 recoater
514 material supply unit
515 additive manufacturing unit
516 collection unit
517 stage
518 stage
530 control unit
56 temperature sensor
57 pressure sensor
58 oxygen sensor
611 material type energy density range database
612 selection parameter and setting range database
613 parameter set and result database
62 data processing unit
63 algorithm selection unit
64 parameter set construction unit
66 defect database
661 monitoring information database
662 defect determination result database
663 recipe and defect rate database
67 data processing unit
68 algorithm selection unit
69 defect determination unit
71 material physical property data
72 recipe
73 parameter setting range
74 initial learning recipe derivation number
75 recipe
81 powder bed
82 powder bed
83, 85 scanning line
84 beam spot
91 contour line
92 contour line irradiation region
931 to 939 scanning line
941 to 949 scanning line

1. An additive manufacturing condition search device, comprising:
a defect database that accumulates a material, shape information, an additive manufacturing condition, monitoring information during modeling, and defect information in association with each other;
a first machine learning unit that outputs an additive manufacturing condition corresponding to material information and device information, and outputs a new additive manufacturing condition from a combination of a plurality of the additive manufacturing conditions and the defect information;
a specification unit that causes an additive manufacturing apparatus to perform modeling by the additive manufacturing condition, acquires the monitoring information during modeling, and acquires the shape information and the defect information by inspection of a modeled object;
a second machine learning unit in which a model trained by using the defect database as train data estimates defect information of the modeled object from the monitoring information and stores the defect information in the defect database; and
a determination unit that determines whether or not the defect information of the modeled object has achieved an evaluation target value.

2. The additive manufacturing condition search device according to claim 1, further comprising an input unit that receives a modeling result of a standard sample manufactured by the additive manufacturing apparatus, an additive manufacturing condition corresponding to the modeling result, an evaluation target value of the standard sample, and a search region defined by ranges of the additive manufacturing condition and the modeling result.

3. The additive manufacturing condition search device according to claim 2, further comprising
a generation unit that generates a prediction model indicating a relationship between the additive manufacturing condition and the modeling result based on a setting value of the additive manufacturing condition within the search region and a modeling result in a case where the setting value of the additive manufacturing condition is set in the additive manufacturing apparatus,
wherein the specification unit calculates a prediction value from the prediction model by giving the evaluation target value received by the input unit to the prediction model, and acquires, as an actual measurement value, a result of a verification experiment in which the prediction value is set in the additive manufacturing apparatus.

4. The additive manufacturing condition search device according to claim 3, further comprising an output unit that outputs the prediction value as the setting value of the additive manufacturing condition in a case where the evaluation target value has been achieved.

5. The additive manufacturing condition search device according to claim 3, further comprising a setting unit that adds a combination of the prediction value and the actual measurement value to a combination of the setting value of the additive manufacturing condition and the modeling result, and causes the generation unit to update the prediction model in a case where the actual measurement value has not achieved the evaluation target value.

6. The additive manufacturing condition search device according to claim 2,
wherein the standard sample is a hexahedron having at least three smooth surfaces, and
concerns, as three types of regions set under the additive manufacturing condition, a filling region of a modeling region, a region that forms an overhanging, and a region that forms an outermost surface in a modeling height direction, and has one surface in which punched pit shapes constituted by straight lines and curved lines are aggregated.

7. The additive manufacturing condition search device according to claim 2, wherein slice data of the standard sample includes at least two or more independent regions in any one layer of a central portion in a stacking direction, and has a small region cut at a predetermined width from an outer edge of the standard sample and a large region constituted by other portions.

8. The additive manufacturing condition search device according to claim 2, further comprising a recipe database that stores a material type, a material physical property, and an additive manufacturing condition and a manufacturing result for each material performed in the past.

9. The additive manufacturing condition search device according to claim 8, wherein, when a material type and a material physical property for searching for the additive manufacturing condition are input, the first machine learning unit calculates a setting range of an energy density from a heat source output, a scanning speed, a scanning line interval, and a stacking thickness which are control factors for filling an inside of the modeled object based on the recipe database.

10. The additive manufacturing condition search device according to claim 9, wherein the first machine learning unit receives input of the setting range of the energy density.

11. The additive manufacturing condition search device according to claim 9, wherein the first machine learning unit assigns an additive manufacturing condition for initial learning in accordance with the setting range of the energy density.

12. The additive manufacturing condition search device according to claim 9, wherein the first machine learning unit receives selection of the control factor and input of a setting range of the control factor.

13. The additive manufacturing condition search device according to claim 12, wherein the first machine learning unit assigns a higher-order item, a lower-order item, and a setting order to the control factor.

14. An additive manufacturing condition search method comprising:
a step of outputting an additive manufacturing condition corresponding to material information and device information or outputting a new additive manufacturing condition from a combination of a plurality of additive manufacturing conditions and defect information;
a step of causing an additive manufacturing apparatus to perform modeling by the additive manufacturing condition, acquiring monitoring information during modeling, and acquiring shape information and defect information by inspection of a modeled object;
a step of estimating, by a model trained by using, as train data, a defect database as a combination of the monitoring information during modeling and the defect information, defect information of the modeled object from the monitoring information, and storing the defect information in the defect database; and
a step of determining whether or not the defect information of the modeled object has achieved an evaluation target value.
